(19) United States
(12) Patent Application Publication
(10) Pub. No.: US 2019/0009506 A1
(43) Pub. Date: Jan. 10, 2019

(54) MULTILAYER FILM AND PRODUCTION METHOD

(71) Applicant: ZEON CORPORATION, Chiyoda-ku, Tokyo (JP)

(72) Inventor: Takuya MIURA, Tokyo (JP)

(73) Assignee: ZEON CORPORATION, Chiyoda-ku, Tokyo (JP)

(21) Appl. No.: 16/075,278

(22) PCT Filed: Feb. 13, 2017
(86) PCT No.: PCT/JP2017/005196

§ 371 Date: Aug. 3, 2018

(30) Foreign Application Priority Data
Feb. 29, 2016 (JP) 2016-037290

(51) Int. Cl. B32B 27/08; B29C 47/06; B29C 47/00; B32B 27/30; C08F 8/42

(52) U.S. Cl. CPC B32B 27/08; B29C 47/065; B29C 47/0004; B29L 2009/00; B32B 27/302; C08F 8/42; B29C 47/0021

(57) ABSTRACT

A multilayer film including: a first resin layer formed of a resin [I]; and a second resin layer that is disposed on at least one surface of the first resin layer and formed of a resin [II], wherein the resin [I] contains an alkoxysilyl modified product [3] of a hydrogenated product of a block copolymer, and an ester compound [4], the alkoxysilyl modified product [3] is an alkoxysilyl group-modified product of a hydrogenated product [2] obtained by hydrogenating 90% or more of an unsaturated carbon-carbon bond in a main chain and a side chain of a block copolymer [1] and an unsaturated carbon-carbon bond of an aromatic ring of the block copolymer [1], and a ratio of the ester compound [4] in the resin [I] is 0.1% by weight to 10% by weight.

### FIELD

The present invention relates to a multilayer film and a method for producing the multilayer film.

### BACKGROUND

There is known an alkoxysilyl group-modified product which is obtained by introducing an alkoxysilyl group to a hydrogenated product obtained by hydrogenating a block copolymer of an aromatic vinyl compound and a chain conjugated diene compound (hereinafter, this polymer may be simply referred to as an “alkoxysilyl group-modified product”) (Patent Literatures 1 and 2). A resin containing such an alkoxysilyl group-modified product is excellent in transparency, heat resistance, weather resistance, and adhesiveness with inorganic materials such as glass and metal. Therefore, such a resin may be used in various use applications such as optical applications. For example, a film formed with such a resin may be used in an optical device including an organic light-emitting layer, such as an organic electroluminescent display device and an organic electroluminescent light-emitting device, as a material for sealing a light-emitting element containing such an organic light-emitting layer.

### CITATION LIST

### Patent Literature

Patent Literature 1: International Publication No. 2012/043708 (corresponding foreign publication: European Patent Application Publication No. 2623526)

Patent Literature 2: Japanese Patent Application Laid-Open No. 2015-104859 A

### SUMMARY

### Technical Problem

An example of a method for producing a film of a resin containing an alkoxysilyl group-modified product may be a method including an extrusion molding step. Specifically, the film may be efficiently produced by using a melt extrusion molding machine containing a screw extruder and a die to pressure-feed a resin from the screw extruder to the die, to thereby extrude a film-shaped resin from the die.

However, when performing such an extrusion molding step, undesirable contamination of the resin with foreign substances sometimes occurs, resulting in reduction in the optical performance of the obtained film. As a method for reducing such contamination with foreign substances, it is conceivable to reduce the generation of the foreign substances or perform an operation of removing foreign substances during the production process. However, such methods can cause disadvantages such as an increased cost of a production apparatus, a complicated production process, and reduced production efficiency. Therefore, there is a demand for a film which can be produced while reducing such foreign substances, without impairing easiness of production, optical performance, and mechanical properties.

Thus, an object of the present invention is to provide a film which is excellent in all of the easiness of production, optical performance, and mechanical properties, and a film production method which enables easy production of such a film.

### Solution to Problem

The present inventor has conducted studies in order to solve the aforementioned problem, and has found that the generation of foreign substances inside a screw extruder during the extrusion molding of an alkoxysilyl group-modified product can be particularly problematic. The present inventor has further found that such generation of foreign substances in a screw extruder can be reduced by adding a specific compound as a plasticizer to the resin. The present inventor has still further found that, by configuring the film in a form of a specific multilayer film, undesirable phenomena such as bleed-out of such a compound during the production process can be reduced. The present invention has been achieved on the basis of these findings.

That is, the present invention is as follows.
(1) A multilayer film comprising: a first resin layer formed of a resin [I]; and a second resin layer that is disposed on at least one surface of the first resin layer and formed of a resin [II], wherein

the resin [I] contains an alkoxysilyl modified product [3] of a hydrogenated product of a block copolymer, and an ester compound [4],

the alkoxysilyl modified product [3] is an alkoxysilyl group-modified product of a hydrogenated product [2] obtained by hydrogenating 90% or more of an unsaturated carbon-carbon bond in a main chain and a side chain of a block copolymer [1] and an unsaturated carbon-carbon bond of an aromatic ring of the block copolymer [1],

the block copolymer [1] has two or more polymer blocks [A] per one molecule of the block copolymer [1], and one or more polymer blocks [B] per one molecule of the block copolymer [1], the polymer block [A] having an aromatic vinyl compound unit as a main component, the polymer block [B] having a chain conjugated diene compound unit as a main component,

a ratio (wA/wB) of a weight fraction wA of the polymer blocks [A] in the entire block copolymer [1] to a weight fraction wB of the polymer blocks [B] in the entire block copolymer [1] is 20/80 to 60/40, and

a ratio of the ester compound [4] in the resin [I] is 0.1% by weight to 10% by weight.
(2) The multilayer film according to (1), wherein the resin [II] contains a polymer selected from the group consisting of a cyclic olefin polymer, the hydrogenated product [2], the alkoxysilyl modified product [3], and mixtures thereof.
(3) The multilayer film according to (1) or (2), wherein the resin [II] contains no ester compound [4] or a content ratio of the ester compound [4] in the resin [II] is less than 0.1% by weight.
(4) A method for producing the multilayer film according to any one of (1) to (3), comprising

a co-extrusion molding step of coextruding the resin [I] and the resin [II] which are melted.
(5) The method for producing the multilayer film according to (4), wherein

in the co-extrusion molding step, a melt extrusion molding machine including a screw extruder and a die is used, and

the co-extrusion molding step includes pressure-feeding the resin [I] from the screw extruder to the die.

### Advantageous Effects of Invention

The multilayer film of the present invention can be a film which is excellent in all of the easiness of production, optical performance, and mechanical properties. According to the method for producing the multilayer film of the present invention, such a multilayer film of the present invention can be easily produced.

### BRIEF DESCRIPTION OF DRAWINGS

FIG. 1 is a cross-sectional view schematically illustrating an example of the multilayer film of the present invention.

FIG. 2 is a side view schematically illustrating an example of the melt extrusion molding machine for performing the method for producing the multilayer film according to the present invention and the production method according to the present invention using the melt extrusion molding machine.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, “polarizing plate” includes not only a rigid member, but also a flexible member, such as, for example, a resin film, unless otherwise specified.

[1. Summary Of Multilayer Film]

The multilayer film of the present invention includes a first resin layer formed of a specific resin [I], and a second resin layer that is disposed on at least one surface of the first resin layer and formed of a resin [II].

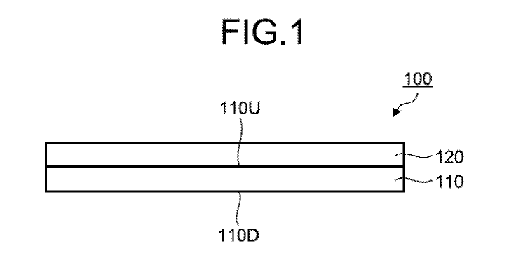

FIG. 1 is a cross-sectional view schematically illustrating an example of the multilayer film of the present invention. In FIG. 1, the multilayer film 100 includes a first resin layer 110, and a second resin layer 120 disposed on one surface 110U of the first resin layer 110. In this example, the other surface 110D of the first resin layer 110 is exposed at the outer surface of the multilayer film 100.

[2. First Resin Layer]

The first resin layer is a layer formed of the resin [I]. The resin [I] contains a specific alkoxysilyl modified product [3] and an ester compound [4]. The alkoxysilyl modified product [3] is an alkoxysilyl group-modified product of a hydrogenated product [2] obtained by hydrogenating unsaturated bonds in a specific block copolymer [1].

[2.1. Block Copolymer [1]]

The block copolymer [I] is a block copolymer having two or more polymer blocks [A] per one molecule of the block copolymer [1], and one or more polymer blocks [B] per one molecule of the block copolymer [1].

The polymer block [A] is a polymer block having an aromatic vinyl compound unit as a main component. Herein, the aromatic vinyl compound unit refers to a structural unit having a structure formed by polymerizing an aromatic vinyl compound.

Examples of the aromatic vinyl compound corresponding to the aromatic vinyl compound unit included in the polymer block [A] may include styrene; styrenes having an alkyl group of 1 to 6 carbon atoms as a substituent, such as a-methylstyrene, 2-methylstyrene, 3-methylstyrene, 4-methylstyrene, 2,4-dimethylstyrene, 2,4-diisopropylstyrene, 4-t-butylstyrene, and 5-t-butyl-2-methylstyrene; styrenes having a halogen atom as a substituent, such as 4-chlorostyrene, dichlorostyrene, and 4-monofluorostyrene; styrenes having an alkoxy group of 1 to 6 carbon atoms as a substituent, such as 4-methoxystyrene; styrenes having an aryl group as a substituent, such as 4-phenylstyrene; and vinylnaphthalenes such as 1-vinylnaphthalene and 2-vinylnaphthalene. One type of these may be solely used, and two or more types thereof may also be used in combination at any ratio. Among these, an aromatic vinyl compound containing no polar group, such as styrene and styrenes having 1 to 6 carbon atoms as a substituent is preferable from the viewpoint of hygroscopicity. From the viewpoint of industrial availability thereof, styrene is particularly preferable.

The content ratio of the aromatic vinyl compound unit in the polymer block [A] is preferably 90% by weight or more, more preferably 95% by weight or more, and particularly preferably 99% by weight or more. When the polymer block [A] contains the large amount of the aromatic vinyl compound unit as described above, heat resistance of the first resin layer can be increased.

The polymer block [A] may contain an optional structural unit other than the aromatic vinyl compound unit. The polymer block [A] may contain one type of optional structural unit solely, and may contain two or more types of optional structures in combination at any ratio.

An example of the optional structural unit that may be contained in the polymer block [A] may be a chain conjugated diene compound unit. Herein, the chain conjugated diene compound unit refers to a structural unit having a structure formed by polymerizing a chain conjugated diene compound. Examples of the chain conjugated diene compound corresponding to the chain conjugated diene compound unit may include the same examples as those exemplified as the examples of the chain conjugated diene compound corresponding to the chain conjugated diene compound unit that is contained in the polymer block [B].

Examples of the optional structural unit that may be contained in the polymer block [A] may include structural units having a structure formed by polymerizing an optional unsaturated compound other than the aromatic vinyl compound and chain conjugated diene compound. Examples of the optional unsaturated compound may include a vinyl compound, such as a chain vinyl compound and a cyclic vinyl compound; an unsaturated cyclic acid anhydride; and an unsaturated imide compound. These compounds may contain a substituent such as a nitrile group, an alkoxycarbonyl group, a hydroxycarbonyl group, or a halogen group. Among these, from the viewpoint of hygroscopicity, vinly compounds having no polar group, such as chain olefins of 2 to 20 carbon atoms per molecule, such as ethylene, propylene, 1-butene, 1-pentene, 1-hexene, 1-heptene, 1-octene, 1-nonene, 1-decene, 1-dodecene, 1-eicocene, 4-methyl-1-pentene, 4,6-dimethyl-1-heptene, and the like; and cyclic olefins of 5 to 20 carbon atoms per molecule, such as vinyl cyclohexane and the like are preferable. Chain olefins of 2 to 20 carbon atoms per molecule are more preferable, and ethylene and propylene are particularly preferable.

The content ratio of the optional structural unit in the polymer block [A] is usually 10% by weight or less, preferably 5% by weight or less, and more preferably 1% by weight or less.

The number of the polymer block [A] in one molecule of the block copolymer [1] is preferably 2 or more, and is preferably 5 or less, more preferably 4 or less, and particularly preferably 3 or less. A plurality of polymer blocks [A] in one molecule may be the same as or different from one another.

When a plurality of different polymer blocks [A] are present in one molecule of the block copolymer [1], the weight-average molecular weight of a polymer block having a maximum weight-average molecular weight in the polymer blocks [A] is denoted as Mw(A1) and the weight-average molecular weight of a polymer block having a minimum weight-average molecular weight in the polymer blocks [A] is denoted as Mw(A2). In this case, a ratio “Mw(A1)/Mw(A2)” of Mw(A1) to Mw(A2) is preferably 4.0 or less, more preferably 3.0 or less, and particularly preferably 2.0 or less. By setting the ratio in this manner, it is possible to suppress the fluctuation in various property values. The lower limit of Mw(A1)/Mw(A2) may be 1.0 or more.

The polymer block [B] is a polymer block having the chain conjugated diene compound unit as a main component. As described above, the chain conjugated diene compound unit refers to a structural unit having a structure formed by polymerizing a chain conjugated diene compound.

Examples of the chain conjugated diene compound corresponding to the chain conjugated diene compound unit that is contained in the polymer block [B] may include 1,3-butadiene, isoprene, 2,3-dimethyl-1,3-butadiene, and 1,3-pentadiene. One type of these may be solely used, and two or more types thereof may also be used in combination at any ratio. Among these, the chain conjugated diene compounds containing no polar group are preferable from the viewpoint of hygroscopicity. Specifically, 1,3-butadiene and isoprene are particularly preferable.

The content ratio of the chain conjugated diene compound unit in the polymer block [B] is preferably 70% by weight or more, more preferably 80% by weight or more, and particularly preferably 90% by weight or more. When the polymer block [B] contains the large amount of the chain conjugated diene compound unit as described above, flexibility of the first resin layer can be improved.

The polymer block [B] may contain an optional structural unit other than the chain conjugated diene compound unit. The polymer block [B] may contain one type of the optional structural unit solely, and may contain two or more thereof in combination at any ratio.

Examples of the optional structural unit that may be contained in the polymer block [B] may include an aromatic vinyl compound unit, and a structural unit having a structure formed by polymerizing an optional unsaturated compound other than the aromatic vinyl compound and the conjugated diene compound. Examples of the aromatic vinyl compound unit and the structural unit having a structure formed by polymerizing an optional unsaturated compound may include the same examples as those exemplified as the units that may be contained in the polymer block [A].

The content ratio of the optional structural unit in the polymer block [B] is preferably 30% by weight or less, more preferably 20% by weight or less, and particularly preferably 10% by weight or less. When the content ratio of the optional structural unit in the polymer block [B] is made low, flexibility of the first resin layer can be improved.

The number of the polymer block [B] in one molecule of the block copolymer [1] is usually 1 or more, and may be 2 or more. When the number of the polymer block [B] in the block copolymer [1] is 2 or more, the polymer blocks [B] may be the same as or different from one another.

When a plurality of different polymer blocks [B] are present in one molecule of the block copolymer [1], the weight-average molecular weight of a polymer block having a maximum weight-average molecular weight in the polymer blocks [B] is denoted as Mw(B1) and the weight-average molecular weight of a polymer block having a minimum weight-average molecular weight in the polymer blocks [B] is denoted as Mw(B2). In this case, a ratio “Mw(B1)/Mw(B2)” of Mw(B1) to Mw(B2) is preferably 4.0 or less, more preferably 3.0 or less, and particularly preferably 2.0 or less. By setting the ratio in this manner, it is possible to suppress the fluctuation in various property values. The lower limit of Mw(B1)/Mw(B2) may be 1.0 or more.

The form of the block of the block copolymer [1] may be a chain block or radial block. Among these, a chain block is preferable because of excellent mechanical strength. When the block copolymer [1] has the form of the chain block, the block copolymer [1] having the polymer blocks [A] at both ends thereof can suppress stickiness of the resin [I] to a desired low value, and thus it is preferable.

The particularly preferable block form of the block copolymer [1] may include a triblock copolymer represented by [A]-[B]-[A] in which the polymer blocks [A] are bonded to both ends of the polymer block [B]; and a pentablock copolymer represented by [A]-[B]-[A]-[B]-[A] in which the polymer blocks [B] are bonded to both ends of the polymer block [A] and polymer blocks [A] are further bonded to respective other ends of the polymer blocks [B]. Among these, the triblock copolymer of [A]-[B]-[A] is particularly preferable because it can be easily produced and its properties can be easily set within desired ranges.

In the block copolymer [1], a ratio (wA/wB) of the weight fraction wA of the polymer blocks [A] in the entire block copolymer [1] to the weight fraction wB of the polymer blocks [B] in the entire block copolymer [1] falls within a specific range. Specifically, the aforementioned ratio (wA/wB) is usually 20/80 or more, preferably 25/75 or more, more preferably 30/70 or more, and particularly preferably 40/60 or more, and is usually 60/40 or less, and preferably 55/45 or less. When the aforementioned ratio wA/wB is equal to or more than the lower limit value of the aforementioned range, heat resistance of the first resin layer can be improved and birefringence can be reduced. When the ratio wA/wB is equal to or less than the upper limit value, flexibility of the first resin layer can be enhanced. Herein, the weight fraction of wA of the polymer blocks [A] represents the weight fraction of the entire polymer blocks [A], and the weight fraction of wB of the polymer blocks [B] represents the weight fraction of the entire polymer blocks [B].

The weight-average molecular weight (Mw) of the block copolymer [1] is preferably 40,000 or more, more preferably 50,000 or more, and particularly preferably 60,000 or more, and is preferably 200,000 or less, more preferably 150,000 or less, and particularly preferably 100,000 or less.

The molecular weight distribution (Mw/Mn) of the block copolymer [1] is preferably 3 or less, more preferably 2 or less, and particularly preferably 1.5 or less, and is preferably 1.0 or more. Herein, Mn represents a number-average molecular weight.

The weight-average molecular weight (Mw) and the molecular weight distribution (Mw/Mn) mentioned above may be measured as a polystyrene-equivalent value by gel permeation chromatography (GPC) using tetrahydrofuran (THF) as a solvent.

Examples of the method for producing the block copolymer [1] may include a method in which a monomer mixture (a) containing an aromatic vinyl compound as a main component and a monomer mixture (b) containing a chain conjugated diene compound as a main component are alternately polymerized by a method such as living anionic polymerization; and a method in which a monomer mixture (a) containing an aromatic vinyl compound as a main component and a monomer mixture (b) containing a chain conjugated diene compound as a main component are polymerized in order and both ends of the polymer blocks [B] are coupled by a coupling agent.

The content of the aromatic vinyl compound in the monomer mixture (a) is usually 90% by weight or more, preferably 95% by weight or more, and more preferably 99% by weight or more. The monomer mixture (a) may contain an optional monomer component other than the aromatic vinyl compound. Examples of the optional monomer component may include a chain conjugated diene compound and an optional unsaturated compound. The amount of the optional monomer component is usually 10% by weigh or less, preferably 5% by weight or less, and more preferably 1% by weight or less relative to the monomer mixture (a).

The content of the chain conjugated diene compound in the monomer mixture (b) is usually 70% by weight or more, preferably 80% by weight or more, and more preferably 90% by weight or more. The monomer mixture (b) may contain an optional monomer component other than the chain conjugated diene compound. Examples of the optional monomer component may include an aromatic vinyl compound and an optional unsaturated compound. The amount of the optional monomer component is usually 30% by weigh or less, preferably 20% by weight or less, and more preferably 10% by weight or less, relative to the monomer mixture (b).

Examples of the method for obtaining respective polymer blocks by polymerizing a monomer mixture may include radical polymerization, anionic polymerization, cationic polymerization, coordination anionic polymerization, and coordination cationic polymerization. From the viewpoint of facilitating the polymerization operation and the hydrogenation reaction in the later step, a method of performing radical polymerization, anionic polymerization, and cationic polymerization by living polymerization is preferable, and a method of performing polymerization by living anionic polymerization is particularly preferable.

Polymerization may be performed in the presence of a polymerization initiator. When living anionic polymerization is adopted, examples of the polymerization initiator for use may include monoorganolithium such as n-butyllithium, sec-butyllithium, t-butyllithium, hexyllithium, and phenyllithium; and a polyfunctional organolithium compound such as dilithiomethane, 1,4-dilithiobutane, and 1,4-dilithio-2-ethylcyclohexane. One type of these may be solely used, and two or more types thereof may also be used in combination at any ratio.

The polymerization temperature is preferably 0° C. or higher, more preferably 10° C. or higher, and particularly preferably 20° C. or higher, and is preferably 100° C. or lower, more preferably 80° C. or lower, and particularly preferably 70° C. or lower.

Examples of the style of the polymerization reaction to be adopted may include solution polymerization and slurry polymerization. Among these, when solution polymerization is used, removal of reaction heat is facilitated.

When the solution polymerization is performed, an inert solvent in which polymers obtained in respective steps can be dissolved may be used as the solvent. Examples of the inert solvent may include aliphatic hydrocarbon solvents such as n-butane, n-pentane, isopentane, n-hexane, n-heptane, and isooctane; alicyclic hydrocarbon solvents such as cyclopentane, cyclohexane, methylcyclopentane, methylcyclohexane, decalin, bicycle[4.3.0]nonane, and tricycle[4.3.0.1^{2,5}]decane; and aromatic hydrocarbon solvents such as benzene and toluene. One type of these may be solely used, and two or more types thereof may also be used in combination at any ratio. Among these, when an alicyclic hydrocarbon solvent is used as a solvent, the alicyclic hydrocarbon solvent as it is can be used also in the hydrogenation reaction as an inert solvent, and the solubility of the block copolymer [1] is favorable, and thus it is preferable. The using amount of the solvent is preferably 200 parts by weight to 2,000 parts by weight relative to 100 parts by weight of the total of the monomers to be used.

When each of the monomer compositions contains two or more types of monomers, a randomizer may be used to prevent a chain of a particular component from being excessively elongated. In particular, when the polymerization reaction is anionic polymerization, it is preferable to use a Lewis base compound as the randomizer, for example. Examples of the Lewis base compound may include an ether compound such as dimethyl ether, diethyl ether, diisopropyl ether, dibutyl ether, tetrahydrofuran, diphenyl ether, ethylene glycol diethyl ether, and ethylene glycol methyl phenyl ether; a tertiary amine compound such as tetramethyl ethylene diamine, trimethylamine, triethylamine, and pyridine; an alkali metal alkoxide compound such as potassium-t-amyloxide and potassium-t-butyloxide; and a phosphine compound such as triphenyl phosphine. One type of these may be solely used, and two or more types thereof may also be used in combination at any ratio.

[2.2. Hydrogenated Product [2]]

The hydrogenated product [2] is a polymer obtained by hydrogenating an amount that is a specific amount or more of the unsaturated bond of the block copolymer [1]. Herein, the unsaturated bond of the block copolymer [1] to be hydrogenated includes both the aromatic and nonaromatic unsaturated carbon-carbon bonds in the main chain and the side chain of the block copolymer [1].

In the present invention, the hydrogenation rate of the hydrogenated product [2] is a high value that is equal to or more than a specific value. Herein, the hydrogenation rate of the hydrogenated product [2] is a ratio of the hydrogenated bonds among the unsaturated carbon-carbon bonds in the main chain and the side chain of the block copolymer [1] and the unsaturated carbon-carbon bonds of the aromatic ring of the block copolymer [1]. The hydrogenation rate of the hydrogenated product [2] is 90% or more, preferably 97% or more, and more preferably 99% or more. As the hydrogenation rate is higher, the transparency, heat resistance, and weather resistance of the first resin layer can be made favorable, and birefringence of the first resin layer can be easily reduced. Herein, the hydrogenation rate of the hydrogenated product [2] may be determined by ¹H-NMR measurement. The upper limit of the hydrogenation rate of the hydrogenated product [2] may be 100% or less.

In particular, the hydrogenation rate of the non-aromatic unsaturated carbon-carbon bond is preferably 95% or more, and more preferably 99% or more. By increasing the hydrogenation rate of the non-aromatic unsaturated carbon-carbon bond, the light resistance and oxidation resistance of the first resin layer can be further enhanced.

The hydrogenation rate of the aromatic unsaturated carbon-carbon bond is preferably 90% or more, more preferably 93% or more, and particularly preferably 95% or more. By increasing the hydrogenation rate of the aromatic unsaturated carbon-carbon bond, the glass transition temperature of the polymer block obtained by hydrogenating the polymer block [A] can be increased, and thus the heat resistance of the first resin layer can be effectively enhanced. Furthermore, the photoelastic coefficient of the first resin layer can be reduced.

The weight-average molecular weight (Mw) of the hydrogenated product [2] is preferably 40,000 or more, more preferably 50,000 or more, and particularly preferably 60,000 or more, and is preferably 200,000 or less, more preferably 150,000 or less, and particularly preferably 100,000 or less. When the weight-average molecular weight (Mw) of the hydrogenated product [2] falls within the aforementioned range, mechanical strength and heat resistance of the first resin layer can be improved. Furthermore, birefringence of the first resin layer can be easily reduced.

The molecular weight distribution (Mw/Mn) of the hydrogenated product [2] is preferably 3 or less, more preferably 2 or less, and particularly preferably 1.5 or less, and is preferably 1.0 or more. When the molecular weight distribution (Mw/Mn) of the hydrogenated product [2] falls within the aforementioned range, mechanical strength and heat resistance of the first resin layer can be improved. Furthermore, the birefringence of the first resin layer can be easily reduced.

The weight-average molecular weight (Mw) and the molecular weight distribution (Mw/Mn) of the hydrogenated product [2] may be measured as a polystyrene-equivalent value by gel permeation chromatography (GPC) using tetrahydrofuran as a solvent.

The aforementioned hydrogenated product [2] may be produced by hydrogenating the block copolymer [1]. As the hydrogenation method, a hydrogenation method that can achieve high hydrogenation rate with less chain cleavage reaction of the block copolymer [1] is preferable. Examples of such a hydrogenation method may include methods disclosed in International Publication Nos. 2011/096389, and 2012/043708.

Specific examples of the hydrogenation method may include a method of performing hydrogenation using a hydrogenation catalyst containing at least one type of metal selected from the group consisting of nickel, cobalt, iron, rhodium, palladium, platinum, ruthenium, and rhenium. As the hydrogenation catalyst, one type thereof may be solely used, and two or more types thereof may also be used in combination at any ratio. The hydrogenation catalyst for use may be any of a heterogeneous catalyst and a homogeneous catalyst. It is preferable to perform the hydrogenation reaction in an organic solvent.

As the heterogeneous catalyst, a metal or a metal compound as it is may be used. Alternatively, the metal or metal compound supported on a suitable carrier may be used. Examples of the carrier may include activated carbon, silica, alumina, calcium carbonate, titania, magnesia, zirconia, diatomaceous earth, silicon carbide, and calcium fluoride. The amount of the catalyst to be supported on the carrier is preferably 0.1% by weight or more, and more preferably 1% by weight or more, and is preferably 60% by weight or less, and more preferably 50% by weight or less, relative to the total amount of the catalyst and carrier. The specific surface area of the carrier-type catalyst is preferably 100 m²/g to 500 m²/g. The average pore size of the carrier-type catalyst is preferably 100 Å or more, more preferably 200 Å or more, and is preferably 1000 Å or less, and more preferably 500 Å or less. Herein, the specific surface area may be determined by measuring the adsorbed amount of nitrogen and using the BET formula. The average pore size may be measured by the mercury intrusion technique.

Examples of the homogeneous catalyst may include a catalyst including a compound of nickel, cobalt, or iron in combination with an organometallic compound (for example, an organoaluminum compound and an organolithium compound); and an organometallic complex catalyst of rhodium, palladium, platinum, ruthenium, or rhenium.

Examples of the compound of nickel, cobalt, or iron may include an acetylacetonato compound, a carboxylic acid salt, and a cyclopentadienyl compound of each metal.

Examples of the organoaluminum compound may include alkyl aluminum, such as triethyl aluminum and triisobutyl aluminum; halogenated aluminum, such as diethyl aluminum chloride and ethyl aluminum dichloride; and hydrogenated alkyl aluminum, such as diisobutyl aluminum hydride.

Examples of the organometallic complex catalyst may include a transition metal complex, such as dihydride-tetrakis(triphenylphosphine)ruthenium, dihydride-tetrakis(triphenylphosphine)iron, bis(cyclooctadiene)nickel, and bis(cyclopentadienyl)nickel.

The using amount of the hydrogenation catalyst is preferably 0.01 part by weight or more, more preferably 0.05 part by weight or more, and particularly preferably 0.1 part by weight or more, and is preferably 100 parts by weight or less, more preferably 50 parts by weight or less, and particularly preferably 30 parts by weight or less, relative to 100 parts by weight of the block copolymer [1].

The temperature during the hydrogenation reaction is preferably 10° C. or higher, more preferably 50° C. or higher, and particularly preferably 80° C. or higher, and is preferably 250° C. or lower, more preferably 200° C. or lower, and particularly preferably 180° C. or lower. When the hydrogenation reaction is performed within such a temperature range, high hydrogenation rate can be achieved, and molecular cleavage of the block copolymer [1] can be suppressed.

The hydrogen pressure during the hydrogenation reaction is preferably 0.1 MPa or more, more preferably 1 MPa or more, and particularly preferably 2 MPa or more, and is preferably 30 MPa or less, more preferably 20 MPa or less, and particularly preferably 10 MPa or less. When the hydrogenation reaction is performed at such a hydrogen pressure, hydrogenation rate can be achieved, and molecular chain cleavage of the block copolymer [1] can be suppressed, resulting in favorable operability.

The hydrogenated product [2] obtained by the above-described method is usually obtained as a reaction liquid containing the hydrogenated product [2], the hydrogenation catalyst, and the polymerization catalyst. Thus, the hydrogenated product [2] may be collected from the reaction liquid after the hydrogenation catalyst and the polymerization catalyst are removed from the reaction liquid by a method, for example, filtration or centrifugal separation. Examples of the method for collecting the hydrogenated product [2] from the reaction liquid may include a steam coagulation method of removing a solvent from a reaction liquid containing the hydrogenated product [2], by steam stripping; a direct desolvation method of removing a solvent under reduced pressure and heating; and a coagulation method of precipitating or coagulating the hydrogenated product [2] by pouring the reaction liquid into a poor solvent for the hydrogenated product [2].

The form of the collected hydrogenated product [2] is preferably in a form of pellets so that the hydrogenated product can be easily subjected to the following silylation-modification reaction (a reaction for introducing an alkoxysilyl group). For example, the hydrogenated product [2] in a molten state is extruded through a die into a strand shape, cooled, and then cut by a pelletizer to form pellets to be supplied to various molding processes. When a coagulation method is used, the resulting coagulated product may be dried and then made in a molten state and extruded by an extruder, and then made in a form of pellets in the same manner as described above, to be supplied to various molding processes.

[2.3. Alkoxysilyl Group-Modified Product [3]]

The alkoxysilyl group-modified product [3] is a polymer obtained by introducing an alkoxysilyl group to the aforementioned hydrogenated product [2] of the block copolymer [1]. The alkoxysilyl group may be directly bound to the hydrogenated product [2], or may be indirectly bound to the hydrogenated product [2] via, for example, a divalent organic group such as an alkylene group. The alkoxysilyl group-modified product [3] is particularly excellent in adhesiveness with inorganic materials such as glass and metal. Therefore, the first resin layer is usually excellent in the adhesiveness with inorganic materials. Thus, the first resin layer can maintain high adhesiveness with inorganic materials even after exposed to a high temperature and high humidity environment for a long period of time.

The introduction amount of an alkoxysilyl group in the alkoxysilyl group-modified product [3] is preferably 0.1 part by weight or more, more preferably 0.2 part by weight or more, and particularly preferably 0.3 part by weight or more, and is preferably 10 parts by weight or less, more preferably 5 parts by weight or less, and particularly preferably 3 parts by weight or less, relative to 100 parts by weight of the hydrogenated product [2] before the introduction of an alkoxysilyl group. When the introduction amount of an alkoxysilyl group falls within the aforementioned range, the crosslinking degree between alkoxysilyl groups decomposed with moisture and the like can be prevented from becoming excessively high. Therefore, the adhesiveness of the first resin layer to inorganic materials can be maintained at a high level.

The introduction amount of an alkoxysilyl group may be measured by the ¹H-NMR spectrometry. When the introduction amount of an alkoxysilyl group is small, it can be measured by increasing the cumulative number.

Since the introduction amount of an alkoxysilyl group is small, the weight-average molecular weight (Mw) of the alkoxysilyl group-modified product [3] usually does not change significantly from the weight-average molecular weight (Mw) of the hydrogenated product [2] before the introduction of the alkoxysilyl group. However, since the hydrogenated product [2] is subjected to a modification reaction in the presence of a peroxide when an alkoxysilyl group is introduced, the crosslinking reaction and scission reaction of the hydrogenated product [2] tend to proceed, causing the molecular weight distribution to significantly change. The weight-average molecular weight (Mw) of the alkoxysilyl group-modified product [3] is preferably 40,000 or more, more preferably 50,000 or more, and particularly preferably 60,000 or more, and is preferably 200,000 or less, more preferably 150,000 or less, and particularly preferably 100,000 or less. The molecular weight distribution (Mw/Mn) of the alkoxysilyl group-modified product [3] is preferably 3.5 or less, more preferably 2.5 or less, and particularly preferably 2.0 or less, and is preferably 1.0 or more. When the weight-average molecular weight (Mw) and the molecular weight distribution (Mw/Mn) of the alkoxysilyl group-modified product [3] fall within the aforementioned ranges, the favorable mechanical strength and tensile elongation of the first resin layer can be maintained.

The weight-average molecular weight (Mw) and the molecular weight distribution (Mw/Mn) of the alkoxysilyl group-modified product [3] may be measured as a polystyrene-equivalent value by gel permeation chromatography (GPC) using tetrahydrofuran as a solvent.

The alkoxysilyl group-modified product [3] may be produced by introducing an alkoxysilyl group to the hydrogenated product [2] of the aforementioned block copolymer [1]. An example of the method for introducing an alkoxysilyl group to the hydrogenated product [2] may be a method in which the hydrogenated product [2] and an ethylenic unsaturated silane compound are reacted in the presence of a peroxide.

As the ethylenic unsaturated silane compound, those capable of being graft-polymerized with the hydrogenated product [2] and of introducing an alkoxysilyl group into the hydrogenated product [2] may be used. Examples of such an ethylenic unsaturated silane compound may include an alkoxysilane having a vinyl group, such as vinyltrimethoxysilane, vinyltriethoxysilane, dimethoxymethylvinylsilane, and diethoxymethylvinylsilane; an alkoxysilane having an allyl group, such as allyltrimethoxysilane and allyltriethoxysilane; an alkoxysilane having a p-styryl group, such as p-styryltrimethoxysilane and p-styryltriethoxysilane; alkoxysilane having 3-methacryloxypropyl group, such as 3-methacryloxypropyltrimethoxysilane, 3-methacryloxypropylmethyldimethoxysilane, 3-methacryloxypropyltriethoxysilane, and 3-methacryloxypropylmethyldiethoxysilane; an alkoxysilane having 3-acryloxypropyl group, such as 3-acryloxypropyltrimethoxysilane and 3-acryloxypropyltriethoxysilane; and an alkoxysilane having 2-norbornen-5-yl group, such as 2-norbornen-5-yltrimethoxysilane. Among these, vinyltrimethoxysilane, vinyltriethoxysilane, dimethoxymethylvinylsilane, diethoxymethylvinylsilane, allyltrimethoxysilane, allyltriethoxysilane, and p-styryltrimethoxysilane are preferable because the effects of the present invention are easily exerted. As the ethylenic unsaturated silane compound, one type thereof may be solely used, and two or more types thereof may also be used in combination at any ratio.

The amount of the ethylenic unsaturated silane compound is preferably 0.1 part by weight or more, more preferably 0.2 part by weight or more, and particularly preferably 0.3 part by weight or more, and is preferably 10 parts by weight or less, more preferably 5 parts by weight or less, and particularly preferably 3 parts by weight or less, relative to 100 parts by weight of the hydrogenated product [2] before the introduction of the alkoxysilyl group.

As the peroxide, those functioning as a radical reaction initiator may be used. As such a peroxide, an organic peroxide may usually be used. Examples of the organic peroxide may include dibenzoyl peroxide, t-butylperoxyacetate, 2,2-di-(t-butylperoxy)butane, t-butylperoxybenzoate, t-butylcumyl peroxide, dicumyl peroxide, di-t-hexyl peroxide, 2,5-dimethyl-2,5-di(t-butylperoxyhexane), di-t-butyl peroxide, 2,5-dimethyl-2,5-di(t-butylperoxy)hexane-3, t-butyl hydroperoxide, t-butylperoxyisobutyrate, lauloyl peroxide, dipropionyl peroxide, and p-menthane hydroperoxide. Among these, those having a 1-minute half-life temperature of 170° C. to 190° C. are preferable. Specifically, t-butylcumyl peroxide, dicumyl peroxide, di-t-hexyl peroxide, 2,5-dimethyl-2,5-di(t-butylperoxyhexane), di-t-butyl peroxide, and the like are preferable. As the peroxide, one type thereof may be solely used, and two or more types thereof may also be used in combination at any ratio.

The amount of the peroxide is preferably 0.01 part by weight or more, more preferably 0.1 part by weight or more, and particularly preferably 0.2 part by weight or more, and is preferably 5 parts by weight or less, more preferably 3 parts by weight or less, and particularly preferably 2 parts by weight or less, relative to 100 parts by weight of the hydrogenated product [2] before the introduction of the alkoxysilyl group.

The method of bringing the hydrogenated product [2] of the block copolymer [1] into reaction with the ethylenic unsaturated silane compound in the presence of a peroxide may be performed, for example, using a heating kneader and a reaction vessel. A specific example thereof may be a method of performing melting by heating a mixture of the hydrogenated product [2], an ethylenic unsaturated silane compound and a peroxide at the melting temperature of the hydrogenated product [2] or higher and kneading the obtained product for a desired period of time, using a twin-screw kneader, to thereby obtain the alkoxysilyl group-modified product [3]. The specific temperature during kneading is preferably 180° C. or higher, more preferably 190° C. or higher, and particularly preferably 200° C. or higher, and is preferably 240° C. or lower, more preferably 230° C. or lower, and particularly preferably 220° C. or lower. The kneading time is preferably 0.1 minute or more, more preferably 0.2 minute or more, and particularly preferably 0.3 minute or more, and is preferably 15 minutes or less, more preferably 10 minutes or less, and particularly preferably 5 minutes or less. When continuous kneading facilities such as a twin-screw kneader and a mono-screw extruder are used, kneading and extruding may be continuously performed with the residence time falling within the aforementioned range.

The amount of the alkoxysilyl group-modified product [3] in the resin [I] is preferably 90% by weight or more, more preferably 93% by weight or more, further preferably 95% by weight or more, and particularly preferably 97% by weight or more. When the amount of the alkoxysilyl group-modified product [3] in the resin [I] falls within the aforementioned range, the desired effects of the present invention can be stably exerted. The upper limit of the amount of the alkoxysilyl group-modified product [3] in the resin [I] may be 99.9% by weight or less.

[2.4. Ester Compound]

The resin [I] contains the ester compound [4] in addition to the alkoxysilyl group-modified product [3]. When the resin [I] contains the ester compound [4], desired properties such as a small number of foreign substances and a high peel strength can be imparted to the first resin layer.

Examples of the ester compound may include a phosphoric acid ester compound, a carboxylic acid ester compound, a phthalic acid ester compound, and an adipic acid ester compound. As the ester compound, one type thereof may be solely used, and two or more types thereof may also be used in combination at any ratio. Among these, from the viewpoint of favorably exerting desired properties such as a small number of foreign substances and a high peel strength, a carboxylic acid ester compound is preferable.

Examples of the phosphoric acid ester compound may include triphenyl phosphate, tricresyl phosphate, and phenyldiphenyl phosphate.

Examples of the carboxylic acid ester compound may include an aromatic carboxylic acid ester, and an aliphatic carboxylic acid ester.

The aromatic carboxylic acid ester is an ester of an aromatic carboxylic acid and an alcohol.

Examples of the aromatic carboxylic acid used may include benzoic acid, phthalic acid, isophthalic acid, terephthalic acid, trimellitic acid, and pyromellitic acid. As the aromatic carboxylic acid, one type thereof may be solely used, and two or more types thereof may also be used in combination at any ratio.

Examples of the alcohol for use may include straight chain or branched alkyl alcohols. As the alcohol, a monohydric alcohol having one hydroxyl group per molecule may be used, or a polyhydric alcohol having two or more hydroxyl groups per molecule may be used. Specific examples of monohydric alcohols may include n-propanol, isopropanol, n-butanol, isobutanol, tert-butanol, n-pentanol, isopentanol, tert-pentanol, n-hexanol, isohexanol, n-heptanol, isoheptanol, n-octanol, isooctanol, 2-ethylhexanol, n-nonanol, isononanol, n-decanol, isodecanol, lauryl alcohol, myristyl alcohol, palmityl alcohol, and stearyl alcohol. Specific examples of the polyhydric alcohol may include ethylene glycol, diethylene glycol, triethylene glycol, 1,2-propylene glycol, 1,3-propylene glycol, 1,3-butanediol, 1,4-butanediol, 1,5-hexanediol, 1,6-hexanediol, neopentyl glycol, and pentaerythritol. As the alcohol, one type thereof may be solely used, and two or more types thereof may also be used in combination at any ratio.

The aliphatic carboxylic acid ester is an ester of an aliphatic carboxylic acid and an alcohol.

Examples of the aliphatic carboxylic acid may include oxalic acid, malonic acid, succinic acid, glutaric acid, adipic acid, pimelic acid, suberic acid, azelaic acid, sebatic acid, and stearic acid. As the aliphatic carboxylic acid, one type thereof may be solely used, and two or more types thereof may also be used in combination at any ratio.

Examples of the alcohol may include the same examples as those exemplified as the alcohols that may be used for the aromatic carboxylic acid ester. As the alcohol, one type thereof may be solely used, and two or more types thereof may also be used in combination at any ratio.

The number of ester bonds per molecule of the ester compound may be 1 or 2 or more. Therefore, as the ester compound, for example, a polyester compound may be used. The polyester compound can be produced by reacting a divalent or more-valent acid with a polyhydric alcohol, using a monovalent acid or a monovalent alcohol as a stopper as necessary.

Among the above-mentioned ester compounds, those containing an aromatic ring in the molecule are preferable, and those in which an ester bond is bonded to the aromatic ring are particularly preferable. By employing such a compound, desired properties such as a small number of foreign substances and a high peel strength can be satisfactorily exhibited. Therefore, among the above-mentioned ester compounds, aromatic carboxylic acid esters such as a benzoic acid ester, a phthalic acid ester, an isophthalic acid ester, a terephthalic acid ester, a trimellitic acid ester, and a pyromellitic acid ester are preferable, and a benzoic acid ester is particularly preferable. Among the benzoic acid esters, diethylene glycol dibenzoate and pentaerythritol tetrabenzoate are particularly preferred.

The ester compound may function as a plasticizer in the resin [I]. By the function of the ester compound as a plasticizer, production with a small amount of foreign substances can be achieved even in the efficient production using a melt extrusion molding machine including a screw extruder, and as a result, a multilayer film that has a high quality and can be easily produced can be obtained.

The molecular weight of the ester compound is preferably 300 or more, more preferably 400 or more, and particularly preferably 500 or more, and is preferably 2200 or less, more preferably 1800 or less, and particularly preferably 1400 or less. When the molecular weight of the ester compound is equal to or more than the lower limit value of the aforementioned range, bleed-out can be suppressed. When the molecular weight is equal to or less than the upper limit value, function of the ester compound as a plasticizer can be facilitated.

The melting point of the ester compound is preferably 20° C. or higher, more preferably 40° C. or higher, and particularly preferably 50° C. or higher, and preferably 180° C. or lower, more preferably 150° C. or lower, and particularly preferably 120° C. or lower. When the melting point of the ester compound is equal to or higher than the lower limit value of the aforementioned range, bleed-out can be suppressed. When the melting point is equal to or less than the upper limit value, function of the ester compound as a plasticizer can be facilitated.

The ratio of the ester compound in the resin [I] is usually 0.1% by weight or more, preferably 1% by weight or more, and more preferably 2% by weight or more, and is usually 10% by weight or less, preferably 9% by weight or less, and more preferably 8% by weight or less. When the ratio of the ester compound is equal to or more than the lower limit value of the aforementioned range, desired properties such as a small number of foreign substances and a high peel strength can be satisfactorily exhibited. When the ratio thereof is equal to or lower than the upper limit value, haze of the first resin layer can be lowered, so that the transparency of the multilayer film can be improved.

[2.5. Optional Component]

The resin [I] may contain an optional component in addition to the alkoxysilyl group-modified product [3] and the ester compound [4]. As the optional component, one type thereof may be solely used, and two or more types thereof may also be used in combination at any ratio.

Examples of the optional component may include additional plasticizers other than the ester compound [4]. By using an additional plasticizer in addition to the ester compound [4], the glass transition temperature and the elastic modulus of the resin [I] can be adjusted, so that the heat resistance and the mechanical strength of the resin [I] can be adjusted. As the additional plasticizer, those which are easily mixed with the alkoxysilyl group-modified product [3] and do not impair the transparency of the first resin layer by mixing with the additional plasticizer are preferable. Examples of such a plasticizer may include polyisobutene, hydrogenated polyisobutene, hydrogenated polyisoprene, a hydrogenated 1,3-pentadiene-based petroleum resin, a hydrogenated cyclopentadiene-based petroleum resin, and a hydrogenated styrene-indene-based petroleum resin. As the additional plasticizer, one type thereof may be solely used, and two or more types thereof may also be used in combination at any ratio.

When the additional plasticizer is added, the amount thereof is preferably 1 part by weight or more, more preferably 3 parts by weight or more, and particularly preferably 5 parts by weight or more, and is preferably 30 parts by weight or less, more preferably 20 parts by weight or less, and particularly preferably 15 parts by weight or less, relative to 100 parts by weight of the alkoxysilyl group-modified product [3]. When the amount of the plasticizer falls within the aforementioned range, the glass transition temperature and the elastic modulus of the resin [I] can be easily adjusted to respective appropriate ranges.

Other examples of the optional component may include an antioxidant. By using the antioxidant, when the first resin layer is produced by melt-extruding the resin [I], adhesion of the oxidative deteriorated substance of the resin [I] to the lip portion of a die can be suppressed. Examples of the antioxidant may include a phenol-based antioxidant, a phosphorus-based antioxidant, and a sulfur-based antioxidant. As the antioxidant, one type thereof may be solely used, and two or more types thereof may also be used in combination at any ratio.

Among the antioxidants, a phenol-based antioxidant, particularly an alkyl substituted phenol-based antioxidant, is preferable. Specific examples of the alkyl-substituted phenolic antioxidant may include monocyclic phenol-based antioxidants, such as 2,6-di-t-butyl-p-cresol, 2,6-di-t-butyl-4-ethylphenol, 2,6-dicyclohexyl-4-methylphenol, 2,6-diisopropyl-4-ethylphenol, 2,6-di-t-amyl-4-methylphenol, 2, 6-di-t-octyl-4-n-propylphenol, 2,6-dicyclohexyl-4-n-octylphenol, 2-isopropyl-4-methyl-6-t-butylphenol, 2-t-butyl-4-ethyl-6-t-octylphenol, 2-isobutyl-4-ethyl-6-t-hexylphenol, 2-cyclohexyl-4-n-butyl-6-isopropylphenol, and stearyl β-(3,5-di-t-butyl-4-hydroxyphenl)propionate; bicyclic phenol-based antioxidants, such as 2,2′-methylenebis(4-methyl-6-t-butylphenol), 4,4′-butylidenebis(3-methyl-6-t-butylphenol), 4,4′-thiobis(3-methyl-6-t-butylphenol), 2,2′-thiobis(4-methyl-6-t-butylphenol), 4,4′-methylenebis(2,6-di-t-butylphenol), 2,2′-methylenebis[6-(1-methylcyclohexyl)-p-cresol], 2,2′-ethylidenebis(4,6-di-t-butylphenol), 2,2′-butylidenebis(2-t-butyl-4-methylphenol), 3,6-dioxaoctamethylenebis[3-(3-t-butyl-4-hydroxy-5-methylphenyl)propionate], triethyleneglycolbis[3-(3-t-butyl-5-methyl-4-hydroxyphenyl)propionate], 1,6-hexanediolbis[3-(3,5-di-t-butyl-4-hydroxyphenyl)propionate, and 2,2′-thiodiethylenebis[3-(3,5-di-t-butyl-4-hydroxyphenyl)propionate; tricyclic phenol-based antioxidants, such as 1,1,3-tris(2-metyl-4-hydroxy-5-t-butylphenyl)butane, 1,3,5-tris(2,6-dimethyl-3-hydroxy-4-t-butylbenzyl)isocyanurate, 1,3,5-tris[(3,5-di-t-butyl-4-hydroxyphenyl)propionyloxyethyl]isocyanurate, tris(4-t-butyl-2,6-dimethyl-3-hydroxybenzyl)isocyanurate, and 1,3,5-trimethyl-2,4,6-tris(3,5-di-t-butyl-4-hydroxybenzyl)benzene; and tetracyclic phenol-based antioxidants, such as tetrakis[methylene-3-(3,5-t-butyl-4-hydroxyphenyl)propionate]methane.

The amount of the antioxidant is preferably 0.01 part by weight or more, more preferably 0.02 part by weight or more, and particularly preferably 0.05 part by weight or more, and is preferably 1.0 part by weight or less, more preferably 0.5 part by weight or less, and particularly preferably 0.3 part by weight or less, relative to 100 parts by weight of the alkoxysilyl group-modified product [3].

Further examples of the optional components may include stabilizers, such as a heat stabilizer a light stabilizer, a weathering stabilizer, an ultraviolet absorber, and a near-infrared absorber; resin modifiers, such as a lubricant; colorants such as a dye and a pigment; and antistatic agents. Amount of these components may be appropriately selected so as not to impair the object of the present invention.

<2.6. Method For Preparing Resin [I]>

The resin [I] may be prepared by mixing the alkoxysilyl group-modified product [3], the ester compound [4], and, as necessary, an optional component. The resin [I] may also be prepared by mixing a precursor of the alkoxysilyl group-modified product [3] (such as the hydrogenated product [2]), the ester compound [4], and, as necessary, an optional component, and thereafter converting the precursor into the alkoxysilyl group-modified product [3].

Examples of the method for mixing the alkoxysilyl group-modified product [3] and the ester compound [4] may include: (i) a method of dissolving the ester compound [4] in an appropriate solvent, mixing the obtained solution with a solution of the hydrogenated product [2] of the block copolymer [1], removing the solvent to collect a composition containing the hydrogenated product [2] and the ester compound [4], and bringing this composition into reaction with an ethylenic unsaturated silane compound in the presence of a peroxide; (ii) a method of melting the alkoxysilyl group-modified product [3], and kneading with the ester compound [4], using a kneading device such as a twin-screw kneader, a roll, a Brabender instrument, and an extruder; (iii) a method in which, upon bringing the hydrogenated product [2] into reaction with an ethylenic unsaturated silane compound in the presence of peroxides, these are kneaded with the ester compound [4]; and (iv) a method of mixing a product obtained by uniformly dispersing the ester compound [4] in the hydrogenated product [2] in a form of pellets and the alkoxysilyl group-modified product [3] in a form of pellets, and melting and kneading the mixture for uniform dispersion. Addition of an optional component may also be performed by a method following any one of these methods.

[2.7. Properties Of Resin [I]]

The resin [I] is preferably transparent. The first resin layer formed of such a transparent resin [I] may be appropriately used for optical applications. Herein, the transparent resin refers to a resin having a total light transmittance of usually 70% or more, preferably 80% or more, and more preferably 90% or more, as measured using a test piece of the resin with a thickness of 1 mm. The total light transmittance may be measured with a UV-visible spectrometer in a wavelength range of 400 nm to 700 nm.

The glass transition temperature Tg_{I} of the resin [I] is preferably 30° C. or higher, more preferably 50° C. or higher, and particularly preferably 70° C. or higher, and is preferably 140° C. or lower, more preferably 120° C. or lower, and particularly preferably 100° C. or lower. When the resin has a plurality of glass transition temperatures, it is preferable that the highest glass transition temperature of the resin falls within the aforementioned range. When the glass transition temperature Tg_{I} of the resin [I] falls within the aforementioned range, the first resin layer can have a favorable balance between adhesiveness and heat resistance. The glass transition temperature Tg_{I} of the resin [I] may be determined as the peak top value of tan δ in the viscoelasticity spectrum.

The temperature of deflection under load for the resin [I] is preferably 40° C. or higher, and more preferably 45° C. or higher, and is preferably 60° C. or lower, and more preferably 55° C. or lower. When the temperature of deflection under load for the resin [I] falls within the aforementioned range, the multilayer film can be easily produced and have excellent orientation relaxation. The film having excellent orientation relaxation is preferable, because generation of wrinkles due to thermal shrinkage can be suppressed when the film is used as a sealing material for sealing an organic light-emitting layer and the like. The temperature of deflection under load for the resin [I] may be determined by producing a test piece through injection molding, and measuring the temperature under the conditions of Method B and a load of 0.45 MPa in accordance with JIS K7191-2.

[3. Second Resin Layer]

The second resin layer is a layer formed of a resin [II]. The resin [II] may be any resin suitable for use as a material of a general optical film. Preferably, the resin [II] may be a resin containing a polymer [II]. Examples of such a polymer [II] may include a polymer selected from the group consisting of a cyclic olefin polymer, the hydrogenated product [2], the alkoxysilyl modified product [3], and mixtures thereof.

[3.1. Polymer [II]: Cyclic Olefin Polymer]

The cyclic olefin polymer is a polymer of which the structural unit has an alicyclic structure. The resin containing such a cyclic olefin polymer is usually superior in performances such as transparency, size stability, retardation expression, and stretchability at low temperatures.

The cyclic olefin polymer may be a polymer having an alicyclic structure in a main chain, a polymer having an alicyclic structure in a side chain, a polymer having an alicyclic structure in a main chain and a side chain, and a mixture of two or more thereof at any ratio. Among these, a polymer having an alicyclic structure in a main chain is preferable from the viewpoint of mechanical strength and heat resistance.

Examples of the alicyclic structure may include a saturated alicyclic hydrocarbon (cycloalkane) structure and an unsaturated alicyclic hydrocarbon (cycloalkene, cycloalkyne) structure. Among these, a cycloalkane structure and a cycloalkene structure are preferable from the viewpoint of mechanical strength and heat resistance, and a cycloalkane structure is particularly preferable.

The number of carbon atoms constituting the alicyclic structure is preferably 4 or more, and more preferably 5 or more, and is preferably 30 or less, more preferably 20 or less, and particularly preferably 15 or less, per one alicyclic structure. When the number of carbon atoms constituting the alicyclic structure falls within this range, mechanical strength, heat resistance, and moldability of the cyclic olefin resin are highly balanced.

In the cyclic olefin polymer, the ratio of the structural unit having the alicyclic structure may be selected according to the intended use of the multilayer film of the present invention. The ratio of the structural unit having the alicyclic structure in the cyclic olefin polymer is preferably 55% by weight or more, more preferably 70% by weight or more, and particularly preferably 90% by weight or more. When the ratio of the structural unit having the alicyclic structure in the cyclic olefin polymer falls within this range, transparency and heat resistance of the cyclic olefin resin are favorable.

Among the cyclic olefin polymers, a cycloolefin polymer is preferable. The cycloolefin polymer is a polymer having a structure obtained by polymerizing a cycloolefin monomer. The cycloolefin monomer is a compound having a ring structure formed of carbon atoms and having a polymerizable carbon-carbon double bond in the ring structure. Examples of the polymerizable carbon-carbon double bond may include carbon-carbon double bonds capable of causing polymerization such as ring opening polymerization. Examples of the ring structure of the cycloolefin monomer may include a monocycle, a polycycle, a fused polycycle, a bridged ring, and polycycles that are combinations thereof. Among these, a polycyclic cycloolefin monomer is preferable from the viewpoint of highly balanced properties of such as dielectric properties and heat resistance of the obtained polymer.

Preferred examples of the above-described cycloolefin polymer may include a norbornene-based polymer, a monocyclic olefin-based polymer, a cyclic conjugated diene-based polymer, and hydrogenated products thereof. Among these, the norbornene-based polymer is particularly suitable because of its excellent moldability.

Examples of the norbornene-based polymer may include a ring-opening polymer of a monomer having a norbornene structure and a hydrogenated product thereof; and an addition polymer of a monomer having a norbornene structure and a hydrogenated product thereof. Examples of the ring-opening polymer of the monomer having a norbornene structure may include a ring-opening homopolymer of one type of monomers having a norbornene structure, a ring-opening copolymer of two or more types of monomers having a norbornene structure, and a ring-opening copolymer of a monomer having a norbornene structure with another monomer copolymerizable therewith. Examples of the addition polymer of the monomer having a norbornene structure may include an addition homopolymer of one type of monomers having a norbornene structure, an addition copolymer of two or more types of monomers having a norbornene structure, and an addition copolymer of a monomer having a norbornene structure with another monomer copolymerizable therewith. Among these, a hydrogenated product of a ring-opening polymer of a monomer having a norbornene structure is particularly suitable from the viewpoint of moldability, heat resistance, low hygroscopicity, size stability, light-weight property, and the like.

Examples of the monomer having a norbornene structure may include bicyclo[2.2.1]hept-2-ene (common name: norbornene), tricyclo[4.3.0.1^{2,5}]deca-3,7-diene (common name: dicyclopentadiene), 7,8-benzotricyclo[4.3.0.1^{2,5}]dec-3-ene (common name: methanotetrahydrofluorene), tetracyclo[4.4.0.1^{2,5}.1^{7,10}]dodeca-3-ene (common name: tetracyclododecene), and derivatives of these compounds (for example, those with a substituent on the ring). Examples of the substituent may include an alkyl group, an alkylene group, and a polar group. A plurality of these substituents, which may be the same as or different from each other, may be bonded to the ring. As the monomer having a norbornene structure, one type thereof may be solely used, and two or more types thereof may also be used in combination at any ratio.

Examples of the polar group may include a heteroatom, and an atomic group having a heteroatom. Examples of the heteroatom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, an amido group, an imido group, a nitrile group, and a sulfonic acid group. As the polymer constituting the resin [II], a polymer containing such a polar group or a polymer containing no polar group may be preferably used.

Examples of the monomer that is ring-opening copolymerizable with the monomer having a norbornene structure may include monocyclic olefins such as cyclohexene, cycloheptene, and cyclooctene, and derivatives thereof; and cyclic conjugated dienes such as cyclohexadiene and cycloheptadiene, and derivatives thereof. As the monomer that is ring-opening copolymerizable with the monomer having a norbornene structure, one type thereof may be solely used, and two or more types thereof may also be used in combination at any ratio.

The ring-opening polymer of the monomer having a norbornene structure may be produced, for example, by polymerizing or copolymerizing the monomer in the presence of a ring-opening polymerization catalyst.

Examples of the monomer that is addition copolymerizable with the monomer having a norbornene structure may include α-olefins of 2 to 20 carbon atoms such as ethylene, propylene, and 1-butene, and derivatives thereof; cycloolefins such as cyclobutene, cyclopentene, and cyclohexene, and derivatives thereof; and non-conjugated dienes such as 1,4-hexadiene, 4-methyl-1,4-hexadiene, and 5-methyl-1,4-hexadiene. Among these, α-olefin is preferable, and ethylene is more preferable. As the monomer that is addition copolymerizable with the monomer having a norbornene structure, one type thereof may be solely used, and two or more types thereof may also be used in combination at any ratio.

The addition polymer of the monomer having a norbornene structure may be produced, for example, by polymerizing or copolymerizing the monomer in the presence of an addition polymerization catalyst.

The aforementioned hydrogenated products of the ring-opening polymer and the addition polymer may be produced, for example, by hydrogenating an unsaturated carbon-carbon bond, preferably 90% or more thereof, in a solution of the ring-opening polymer and the addition polymer in the presence of a hydrogenation catalyst containing a transition metal such as nickel, palladium, or the like.

Among the norbornene-based polymers, it is preferable that the polymer has an X: bicyclo[3.3.0]octane-2,4-diyl-ethylene structure and a Y: tricyclo[4.3.0.1^{2,5}]decane-7,9-diyl-ethylene structure as structural units, and that the amount of these structural units is 90% by weight or more relative to the entire structural unit of the norbornene-based polymer, and the content ratio of X and Y is 100:0 to 40:60 by weight ratio of X:Y. By using such a polymer, the second resin layer containing the norbornene-based polymer can be made to have excellent stability of optical properties without size change over a long period of time.

Examples of the monocyclic olefin-based polymer may include addition polymers of cyclic olefin-based monomers having a monocycle such as cyclohexene, cycloheptene, cyclooctene, and the like.

Examples of the cyclic conjugated diene polymer may include polymers obtained by cyclizing an addition polymer of a conjugated diene monomer such as 1,3-butadiene, isoprene, chloroprene, and the like; 1,2- or 1,4-addition polymers of a cyclic conjugated diene monomer such as cyclopentadiene, cyclohexadiene, and the like; and hydrogenated products thereof.

The weight-average molecular weight (Mw) of the cyclic olefin polymer may be appropriately selected according to the intended use of the multilayer film, and is preferably 10,000 or more, more preferably 15,000 or more, and particularly preferably 20,000 or more, and is preferably 100,000 or less, more preferably 80,000 or less, and particularly preferably 50,000 or less. When the weight-average molecular weight falls within this range, mechanical strength and moldability of the multilayer film are highly balanced. Herein, the weight-average molecular weight is a polyisoprene- or polystyrene-equivalent weight-average molecular weight measured by gel permeation chromatography using cyclohexane as a solvent (but toluene may be used when the sample is not dissolved in cyclohexane).

The molecular weight distribution (weight-average molecular weight (Mw)/number-average molecular weight (Mn)) of the cyclic olefin polymer is preferably 1.2 or more, more preferably 1.5 or more, and particularly preferably 1.8 or more, and is preferably 3.5 or less, more preferably 3.0 or less, and particularly preferably 2.7 or less. When the molecular weight distribution is equal to or more than the lower limit value, productivity of the polymer can be improved and production cost can be suppressed. When the molecular weight distribution is equal to or less than the upper limit value, the amount of the low molecular component is reduced, so that relaxation at the time of high temperature exposure can be suppressed, and stability of the multilayer film can be enhanced.

As the cyclic olefin polymer and the resin containing the cyclic olefin polymer, a commercially available resin may be used. Examples of the commercially available resin may include ZEONOR (manufactured by ZEON Corporation), ARTON (manufactured by JSR Corp.), TOPAS (manufactured by Polyplastic Corp.), and APEL (manufactured by Mitsui Chemicals Inc.).

[3.2. Polymer [II]: Hydrogenated Product [2] and Alkoxysilyl Modified Product [3]]

As the hydrogenated product [2] and the alkoxysilyl modified product [3] as the polymer [II], the same products as those described as the alkoxysilyl modified product [3] constituting the resin [I] and the hydrogenated product [2] as the precursor thereof may be used.

[3.3. Other Components of Resin [II]]

The resin [II] may contain an optional component in addition to the polymer [II]. For example, the resin [II] may also contain the ester compound [4]. However, from the viewpoint of preventing bleed-out, it is preferable that the resin [II] does not contain the ester compound [4] or, even if it contains the ester compound [4], the content ratio thereof is small. Specifically, the ratio of the ester compound [4] in the resin [II] may preferably be less than 0.1% by weight, more preferably less than 0.05% by weight, and even more preferably less than 0.01% by weight.

The resin [II] may also contain the same materials as those listed as the optional components that the resin [I] may contain. The resin [II] may also contain the ester compound [4]. However, from the viewpoint of preventing bleed-out, it is preferable that the resin [II] does not contain these components or, even if it contains these components, the content ratio thereof is small. Specifically, the ratio of the polymer [II] in the resin [II] may preferably be 98% by weight or more, more preferably 99% by weight or more, and even more preferably 99.5% by weight or more.

[4. Shape And Properties Of Multilayer Film]

The multilayer film of the present invention may be a two-type two-layer film consisting of a single-layer first resin layer and a single-layer second resin layer. However, the multilayer film of the present invention is not limited to this, and may have, for example, one first resin layer and two second resin layers provided on both sides of the first resin layer. The multilayer film of the present invention may also have an optional layer other than the first resin layer and the second resin layer.

The multilayer film of the present invention may be a film containing a small amount of foreign substances in a resin. That is, in the multilayer film of the present invention, the number of non-translucent particles which are observed with the naked eye and through a microscope is small. In particular, the multilayer film may be a film with small number of foreign substances having a size of 100 μm or more in the first resin layer. The foreign substances having “a size of 100 μm or more” refer to foreign substances having a long diameter of 100 μm or more when the film is observed. Specifically, the number of foreign substances having a size of 100 μm or more per 100 mm² of the film area in the first resin layer may be preferably two or less, and more preferably one or less. The small number of foreign substances can be achieved when the resin [I] contains the ester compound [4].

The thickness of each of the first resin layer and the second resin layer is not particularly limited, and may be a desired thickness depending on the use applications. The thickness per layer of each of the first resin layer and the second resin layer is, for example, preferably 5 μm or more, and more preferably 10 μm or more, and is preferably 100 μm or less, and more preferably 50 μm or less. In the multilayer film of the present invention, the ratio of the total thickness of the first resin layer to the total thickness of the second resin layer is preferably about 1 to 1, specifically, in the range of 0.7:1.3 to 1.3:0.7.

The transparency of the multilayer film of the present invention is not particularly limited. However, from the viewpoint that the multilayer film can be usefully used as a member required to transmit light, it is preferable that the multilayer film of the present invention has high transparency. In this case, the total light transmittance of the multilayer film is preferably 70% or more, more preferably 80% or more, and particularly preferably 90% or more.

The haze of the multilayer film of the present invention is not particularly limited. However, when the multilayer film of the present invention is used for an optical application in which diffusion of light is not specifically intended, it is in general preferable that the haze is low. In this case, the haze of the multilayer film of the present invention is preferably 3.0% or less, and more preferably 1.0% or less. The haze may be measured in accordance with JIS K 7136 using a film piece having a size of 50 mm×50 mm obtained by cutting the first resin layer.

It is preferable that the multilayer film of the present invention has sufficiently high adhesiveness with an inorganic material. For example, when the multilayer film of the present invention is directly bonded to a glass plate, the peel strength required for peeling the multilayer film from the glass plate is preferably 15 N/cm or more, and more preferably 20 N/cm or more. The upper limit of the peel strength described above is not particularly limited, but is preferably 200 N/cm or less. Since the alkoxysilyl modified product [3] can exhibit high adhesiveness with an inorganic material such as glass, when only the first resin layer of the first resin layer and the second resin layer contains the alkoxysilyl modified product [3], it is preferable that the first resin layer is located on one or both surfaces of the multilayer film, and the configuration is made such that the first resin layer exhibits a high peel strength between the first resin layer and the inorganic material.

The multilayer film of the present invention preferably has a low moisture permeability. When the multilayer film has a low moisture permeability, it can be preferably used as a material for sealing a light-emitting element including an organic light-emitting layer in an optical device including the organic light-emitting layer. The moisture permeability of the multilayer film of the present invention is preferably 4 g/m²·24 h or less, more preferably 2 g/m²·24 h or less, and ideally 0 g/m²·24 h, under an atmosphere of 40° C. and 90% RH. For obtaining such a low moisture permeability, it is preferable that the second resin layer is a layer containing a cyclic olefin polymer as the polymer [II].

[5. Method for Producing Multilayer Film]

The multilayer film of the present invention may be produced by any production method. Examples of the production method may include a melt molding method and a solution casting method. More particularly, the melt molding method may be classified into an extrusion molding method, a press molding method, an inflation molding method, an injection molding method, a blow molding method, and a stretch molding method. Among these, an extrusion molding method, an inflation molding method, and a press molding method are preferable for obtaining the first resin layer having excellent mechanical strength and surface accuracy. Among these, an extrusion molding method is particularly preferable from the viewpoint of enabling efficient and simple production of the first resin layer. The multilayer film of the present invention is particularly preferably produced by a production method including a coextrusion molding process described hereinafter. Hereinafter, this production method will be described as the method for producing the multilayer film of the present invention.

The method for producing the multilayer film of the present invention includes a coextrusion molding process of coextruding the resin [I] and the resin [II] in a melted state. The coextrusion molding process preferably includes using a melt extrusion molding machine including a screw extruder and a die to pressure-feed the resin [I] from the screw extruder to the die.

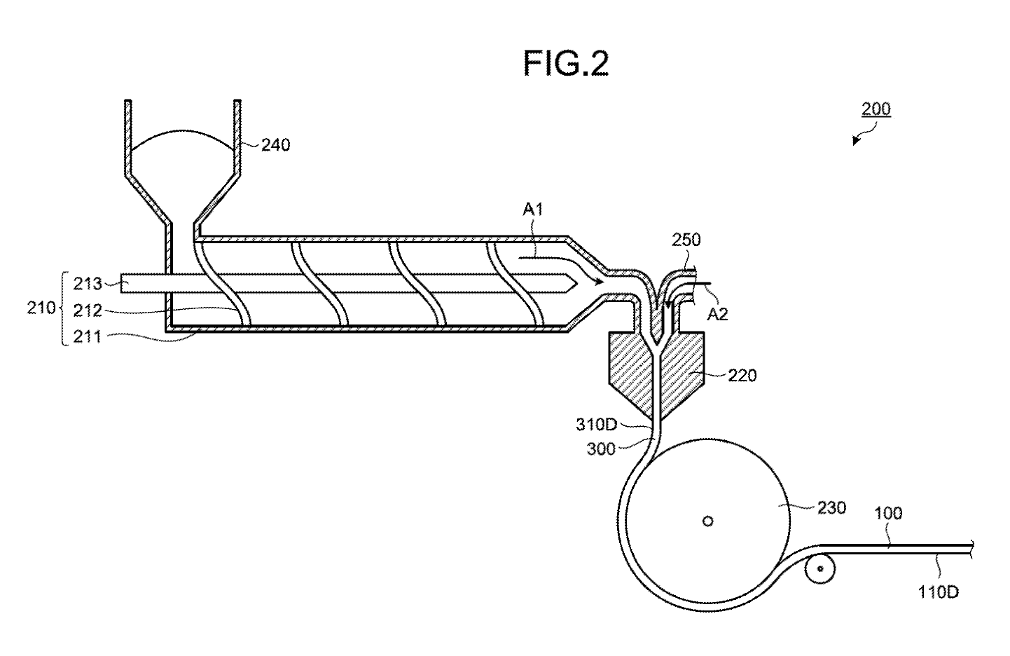

FIG. 2 is a side view schematically illustrating an example of the melt extrusion molding machine for performing the method for producing the multilayer film of the present invention and the production method of the present invention using the melt extrusion molding machine. In FIG. 2, a melt extrusion molding machine 200 is a device for producing the multilayer film 100 illustrated in FIG. 1, that is, a two-type two-layer multilayer film consisting of a single-layer first resin layer 110 formed of the resin [I] and a single-layer second resin layer 120 formed of the resin [II].

The melt extrusion molding machine 200 includes a screw extruder 210 and a T-die 220. The melt extrusion molding machine 200 further includes, as an optional component, a cooling roll 230 disposed downstream of the T-die, a hopper 240 disposed on the upstream end of the screw extruder, and an introduction pipe 250 connected to the T-die. The screw extruder 210 includes a cylinder 211, a shaft 213 disposed inside the cylinder 211, and a screw 212 disposed on the periphery of the shaft 213. The screw 212 is disposed in a rotatable manner such that it rotates with the shaft 213 when the shaft is rotated around its axis, and has a size fitting the inner diameter of the cylinder 211. In FIG. 2, for convenience of illustration, the cylinder 211, the T-die 220, the hopper 240, and the introduction pipe 250 are illustrated by their longitudinal cross sections.

In an operation of the melt extrusion molding machine 200, the resin [I] molded into pellets or the like is charged into the hopper 240, and supplied to the screw extruder 210. The supply amount may be adjusted, if necessary, by a feeder (not illustrated) disposed between the hopper 240 and the screw extruder 210. The temperature inside the screw extruder may be adjusted by a device such as a heater (not illustrated) disposed to the screw extruder. Thus, the resin [I] can be melted. The shaft 213 is rotated to cause the screw 212 to be rotated. Accordingly, the resin [I] in a melted state is pressure-fed in a direction of an arrow A1 to the die 220.

The temperature of the resin [I] in the screw extruder is preferably Tg_{I}+50° C. or higher, and more preferably Tg_{I}+70° C. or higher, and is preferably Tg_{I}+160° C. or lower, and more preferably Tg_{I}+140° C. or lower. Herein, Tg_{I} represents the glass transition temperature of the resin [I]. When the melting temperature in the screw extruder is equal to or higher than the lower limit value, fluidity of the resin [I] can be sufficiently made high. When the melting temperature is equal to or lower than the upper limit value, decrease in molecular weight of the resin [I] due to decomposition can be suppressed.

By performing such pressure-feeding with a screw extruder, efficient production of the multilayer film can be performed. However, the pressure-feeding with a screw extruder also may cause the structure inside the screw extruder to be slightly shaved, with the result that the resin may be contaminated with minute foreign substances. Such contamination with foreign substances can raise a problem particularly when the alkoxysilyl modified product [3] of the block copolymer hydrogenated product is used. However, according to the findings by the present inventor, when the resin [I] contains the ester compound [4] in addition to the alkoxysilyl modified product [3] of the block copolymer hydrogenated product, the number of such foreign substances can be reduced, and a high-quality multilayer film can be efficiently produced.

In the production method of the present invention, the resin [II] can also be pressure-fed in a direction of an arrow A2 to the die 220 through the introduction pipe 250. The pressure-feeding of the resin [II] may be performed by connecting a screw extruder similar to that for the resin [I] with the introduction pipe 250 and operating the connected extruder.

The resin [I] and the resin [II] pressure-fed into the T-die 220 are discharged from the T-die 220 in the shape of a two-type two-layer film. The temperature of the resin [I] and the resin [II] in the T-die may be appropriately adjusted by a device such as a heater (not illustrated) disposed to the T-die, such that the melted state of both the resin [I] and the resin [II] is maintained.

A film 300 discharged in a melted state is supplied onto the circumferential surface of the cooling roll 230. In this example, the supply of the film 300 in a melted state onto the cooling roll 230 is performed in such a manner that a surface 310D on the resin [I] side becomes on the opposite side to a surface to be brought into contact with the cooling roll 230. By performing such supply, the ester compound [4] bled out from the resin [I] can be inhibited from adhering to the cooling roll 230, enabling suppression of fouling of a delivery route and efficient production. The temperature of the cooling roll may be appropriately adjusted to the range in which failures such as slip and scratch can be suppressed.

The cooling by the cooling roll 230 causes the film 300 in a melted state to be cooled, to thereby provide the two-type two-layer multilayer film 100. The obtained multilayer film 100 is taken out from the device, and subjected to an optional treatment as necessary, to thereby complete a product. In the example illustrated in FIG. 2, the multilayer film 100 is efficiently produced as a long-length film. The long-length film refers to a film having a length that is 5 times or more, preferably 10 times or more, its width. Specifically, it refers to a film having a length with which the film can be wound up into a roll shape to be stored or transported. The upper limit of the ratio of the length relative to the width of a film is not particularly limited, and may be, for example, 100,000 times or less.

[6. Use Applications]

The multilayer film of the present invention may be used in various use applications such as optical applications. For example, the multilayer film of the present invention may be used as optical films such as a polarizing plate protective film, a phase difference film, a brightness enhancing film, a transparent electroconductive film, a substrate for touch panels, a liquid crystal substrate, a light diffusing sheet, a prism sheet, and a sealing film. In particular, the multilayer film of the present invention may be favorably used in an optical device including an organic light-emitting layer, such as an organic electroluminescent display device and an organic electroluminescent light-emitting device, as a film for sealing a light-emitting element containing such an organic light-emitting layer.

### EXAMPLES

Hereinafter, the present invention will be specifically described by illustrating Examples. However, the present invention is not limited to the Examples described below. The present invention may be optionally modified for implementation without departing from the scope of claims of the present invention and its equivalents.

In the following description, “%” and “part” representing quantity are on the basis of weight, unless otherwise specified. The operation described below was performed under the conditions of normal temperature and normal pressure, unless otherwise specified.

[Evaluation Method]

[1. Method For Measuring Weight-Average Molecular Weight (Mw) and Molecular Weight Distribution (Mw/Mn)]

The weight-average molecular weight (Mw) and number-average molecular weight (Mn) of the polymer were measured as standard polystyrene-equivalent values by gel permeation chromatography (GPC) using tetrahydrofuran as an eluent. The measurement was performed at 38° C. As the measuring device, “HLC8020GPC” manufactured by Tosoh Corporation was used.

[Method For Measuring Hydrogenation Rate]

The hydrogenation rates of the unsaturated carbon-carbon bonds in the main chain and side chain of the block copolymer and the unsaturated carbon-carbon bonds of the aromatic ring of the hydrogenated product of the block copolymer were calculated by measuring ¹H-NMR spectra.

[3. Number of Foreign Substances]

Each of the multilayer films obtained in Examples and Comparative Examples was observed through an optical microscope. Then, the number of foreign substances having a size of 100 μm or more was counted, and the number per 100 mm² was calculated.

[4. Total Light Transmittance]

Each of the multilayer films obtained in Examples and Comparative Examples was used as a sample and measured according to JIS K 7361 (unit: %).

[5. Peel Strength with Glass]

Each of the multilayer films obtained in Examples and Comparative Examples was cut to have a sample having a shape of a 100 mm×100 mm rectangle. The surface on the first resin layer side of the sample and the surface of glass (500 mm×1000 mm×1.1 mmt) were stacked on each other, and subjected to vacuum degassing at 170° C. for 5 minutes and pressing at 0.1 MPa for 10 minutes, to effect adhesion. Using an Autograph instrument (“AGS-10NX” manufactured by Shimadzu Corporation), the peel strength (unit: N/10 mm) was measured by performing a 180° peeling test of peeling the sample from the glass plate, in accordance with JIS Z 0237. The measurement conditions in this test were a peel speed of 100 mm/min and a temperature of 23° C.

[6. Moisture Permeability]

The moisture permeability of each of the multilayer films obtained in Examples and Comparative Examples was measured according to JIS Z 0208 under ambient conditions of 40° and 90% RH (unit: g/m ²·24 h).

[7. Temperature of Deflection Under Load]

The resin [I] obtained in each of Examples and Comparative Examples was injection-molded to prepare a test piece. The test piece was measured in accordance with JIS K7191-2 under the conditions of Method B and a load of 0.45 MPa.

### Example 1

(1-1. Synthesis of Block Copolymer [1])

A block copolymer was produced with styrene as the aromatic vinyl compound and isoprene as the chain conjugated diene compound according to the following procedure. In the following description, the polymerization conversion ratio was measured by gas chromatography, unless otherwise stated.

Into a reaction vessel equipped with a stirrer in which the atmosphere was sufficiently replaced with nitrogen, 550 parts of dehydrated cyclohexane, 25.0 parts of dehydrated styrene, and 0.475 part of n-dibutyl ether were charged. To the mixture, 0.68 part of n-butyl lithium (15% cyclohexane solution) was added while stirring at 60° C., to thereby initiate polymerization. The reaction was performed for 60 minutes while the mixture was stirred at 60° C. The polymerization conversion ratio at this time point was 99.5%.

Subsequently, 50.0 parts of dehydrated isoprene was added, and the mixture was continuously stirred for 30 minutes. The polymerization conversion ratio at this time point was 99%. Thereafter, 25.0 parts of dehydrated styrene was further added, and the mixture was stirred for 60 minutes. The polymerization conversion ratio at this time point was almost 100%. At this time point, 0.5 part of isopropyl alcohol was added to terminate the reaction. Thus, a polymer solution containing the block copolymer [1] was obtained. The block copolymer [1] had a weight-average molecular weight (Mw) of 61,700 and a molecular weight distribution (Mw/Mn) of 1.05.

(1-2. Production of Hydrogenated Product [2])

Subsequently, the polymer solution containing the block copolymer [1] was transferred into a pressure resistant reaction vessel equipped with a stirrer. To the polymer solution, 3.0 parts of a silica-alumina supported nickel catalyst (“T-8400RL” manufactured by Sud-Chemie Inc.) as a hydrogenation catalyst and 100 parts of dehydrated cyclohexane were added and mixed. The atmosphere in the reaction vessel was replaced with hydrogen gas. Hydrogen was further supplied while the solution was stirred to perform hydrogenation reaction at a temperature of 170° C. and a pressure of 4.5 MPa for 6 hours. Accordingly, the block copolymer [1] in the solution was hydrogenated to obtain a reaction solution containing a hydrogenated product of the block copolymer [1]. This hydrogenated product had a weight average molecular weight (Mw) of 65,300 and a molecular weight distribution (Mw/Mn) of 1.06.

After termination of the hydrogenation reaction, the reaction solution containing the hydrogenated product was filtered to remove the hydrogenation catalyst. Thereafter, to the filtered reaction solution, 1.0 part of a xylene solution in which 0.1 part of tetrakis[methylene-3-(3,5-di-t-butyl-4-hydroxyphenyl)propionate]methane (IRGANOX 1010 manufactured by BASF Japan, Ltd.) as a phenol-based antioxidant was dissolved was added and dissolved.

Subsequently, the reaction solution was filtered through a metal fiber filter (pore size: 0.4 μm, manufactured by Nichidai Co., Ltd.) to remove minute solid content. Thereafter, the solvent cyclohexane and xylene and other volatile matter were removed from the filtered reaction solution using a cylindrical concentration dryer (“Kontro” manufactured by Hitachi, Ltd.) at a temperature of 260° C. and a pressure of 0.001 MPa or less. The solid content in the reaction solution was extruded in a melted state into a strand shape from a die directly connected to the concentration dryer. The extruded melted solids were cooled, and cut by a pelletizer, to thereby obtain 90 parts of pellets of the hydrogenated product [2]. The obtained hydrogenated product [2] had a weight-average molecular weight (Mw) of 64,600 and a molecular weight distribution (Mw/Mn) of 1.11. The hydrogenation rate was almost 100%.

(1-3. Mixing of Ester Compound [4])

As the ester compound [4], pentaerythritol distearate (“Unister H476D” manufactured by NOF Corporation, pentaerythritol distearate (C(CH₂OCOC₁₇H₃₅)₂(CH₂OH)₂), molecular weight: 657, melting point: 53° C.) was prepared.

Using a twin-screw extruder (“TEM35B” manufactured by Toshiba Machine Co. Ltd.), 90 parts of the pellets of the hydrogenated product [2] obtained in (1-2) and 8 parts of the ester compound [4] were kneaded at a resin temperature of 200° C., to thereby obtain a resin containing the hydrogenated product [2] and the ester compound [4]. This resin was extruded into a strand shape from the twin-screw extruder. The extruded resin was water-cooled, and thereafter cut by a pelletizer to obtain pellets.

(1-4. Introduction of Alkoxysilyl Group to Hydrogenated Product [2]: Production of Resin [I])

To 98 parts of the pellets obtained in (1-3), 1.8 parts of vinyltrimethoxysilane and 0.2 part of di-t-butyl peroxide were added. This mixture was kneaded at a resin temperature of 210° C. and a retention time of 80 to 90 seconds using a twin-screw extruder (“TEM37B” manufactured by Toshiba Machine Co. Ltd.). Thereafter, the kneaded resin was extruded into a strand shape. The extruded resin was air-cooled, and thereafter cut by a pelletizer. Thus, 97 parts of pellets of the resin [I] containing the alkoxysilyl group-modified product [3] obtained by introducing an alkoxysilyl group to the hydrogenated product [2], and the ester compound [4] were obtained. The temperature of deflection under load for the obtained resin [I] was measured. The result was 48° C. The obtained resin [I] was analyzed by the ¹H-NMR spectrometry (in deuterochloroform). As a result, an absorption band attributed to the protons of a methoxy group was observed at 3.6 ppm. From the peak area ratio, it was confirmed that 1.7 parts of vinyltrimethoxysilane were bound to 100 parts of the hydrogenated product [2].

(1-5. Production of Resin [II])

Pellets of the resin [II] containing the alkoxysilyl group-modified product [3] (but not containing the ester compound [4]) was obtained in the same manner as that of (1-4), except that 98 parts of the pellets of the hydrogenated product [2] obtained in (1-2) as they were were used in place of the pellets obtained in (1-3).

(1-6. Production and Evaluation of Multilayer Film)

A film melt extrusion molding machine (stationary-type, manufactured by GSI Creos Corporation) was prepared. This film melt extrusion molding machine includes two screw extruders each having a screw diameter of 20 mm, a compression ratio of 3.1, and an L/D of 30, and also includes a two-layer, hanger manifold type T-die (T-die width: 150 mm) for coextrusion.

The resin [I] obtained in (1-4) was charged into one of the two screw extruders, and the resin [II] obtained in (1-5) was charged into the other. The resins were pressure-fed in a melted state from the screw extruders to the T-die. Using the film melt extrusion molding machine, the resins were coextruded, and cooled by a cooling roll to be molded into a two-type two-layer film. The molding conditions were a die lip opening of 0.8 mm, a die lip width of 120 mm, a T-die temperature of 200° C., and a cooling roll temperature of 50° C. For cooling, the film was brought into contact with the cooling roll in such a manner that the surface on the resin [II] side was in contact with the cooling roll. Accordingly, there was obtained a two-type two-layer multilayer film including the first resin layer formed of the resin [I] and the second resin layer formed of the resin [II]. The multilayer film had a thickness of 20 μm. The thickness ratio of the first resin layer:the second resin layer was 1:1.

The obtained multilayer film was evaluated for total light transmittance, peel strength with glass, and water vapor permeability.

(1-7. Production and Evaluation of Single-Layer Film for Evaluation)

A film melt extrusion molding machine (stationary-type, manufactured by GSI Creos Corporation) was prepared. This film melt extrusion molding machine includes one screw extruder having a screw diameter of 20 mm, a compression ratio of 3.1, and an L/D of 30, and also includes a T-die (T-die width: 150 mm) for single-layer extrusion.

The resin [I] obtained in (1-4) in a melted state was charged into the screw extruder, and pressure-fed from the screw extruder to the T-die. Using the film melt extrusion molding machine, the resin was extruded, and cooled by a cooling roll to be molded into a single-layer film. The molding conditions were a die lip opening of 0.8 mm, a die lip width of 120 mm, a T-die temperature of 200° C., and a cooling roll temperature of 50° C. Accordingly, there was obtained a single-layer film including the first resin layer formed of the resin [I]. The single-layer film had a thickness of 20 μm.

The obtained single-layer film was evaluated for the number of foreign substances.

### Example 2

A multilayer film and a single-layer film were obtained and evaluated in the same manner as that of Example 1, except that in the step of mixing the ester compound [4] in (1-3), the amount of the pellets of the hydrogenated product [2] was changed from 90 parts to 93 parts, and the amount of the ester compound [4] was changed from 8 parts to 5 parts.

### Example 3

A multilayer film and a single-layer film were obtained and evaluated in the same manner as that of Example 1, except that when introducing an alkoxysilyl group in (1-4), the added amount of vinyltrimethoxysilane was changed from 1.8 parts to 7.2 parts, and the added amount of di-t-butyl peroxide was changed from 0.2 part to 0.8 part. However, in the step of producing the resin [II] in (1-5), the added amount of vinyltrimethoxysilane was not changed, and was the same as that in (1-4) of Example 1. The obtained resin [I] was analyzed by the ¹H-NMR spectrometry (in deuterochloroform), and the absorption band based on the protons of a methoxy group was observed at 3.6 ppm. From the peak area ratio, it was confirmed that 7.0 parts of vinyltrimethoxysilane were bound to 100 parts of the hydrogenated product [2].

### Example 4

A multilayer film and a single-layer film were obtained and evaluated in the same manner as that of Example 1, except that in the step of mixing the ester compound [4] in (1-3), the amount of the pellets of the hydrogenated product [2] was changed from 90 parts to 97.7 parts, and the amount of the ester compound [4] was changed from 8 parts to 0.3 parts.

### Example 5

A multilayer film and a single-layer film were obtained and evaluated in the same manner as that of Example 1, except that in the step of producing the multilayer film in (1-6), a cyclic olefin polymer resin (product name “ZEONOR1215” manufactured by ZEON Corporation, Tg: approx. 123° C.) was used in place of that obtained in (1-5) as the resin [II], and the T-die temperature was changed from 200° C. to 240° C.

### Comparative Example 1

A multilayer film and a single-layer film were obtained and evaluated in the same manner as that of Example 1, except that in the step of introducing an alkoxysilyl group in (1-4), 98 parts of the pellets of the hydrogenated product [2] obtained in (1-2) were used as they were in place of the pellets obtained in (1-3). That is, a one-type two-layer multilayer film was formed by using only the same resin [II] in place of a combination of the resin [I] and the resin [II] in the step of producing the multilayer film in (1-6).

### Comparative Example 2

A multilayer film and a single-layer film were obtained and evaluated in the same manner as that of Example 1, except for the following points.

in the step of mixing the ester compound [4] in (1-3), 8 parts of liquid paraffin (Wako special grade, manufactured by Wako Pure Chemical Industries, Ltd., melting point: −24° C.), which is a plasticizer of a non-ester compound, was used in place of 8 parts of pentaerythritol distearate as the ester compound [4].

When producing the multilayer film in (1-6), pellets of polyethylene terephthalate (“TRN-8550FF” manufactured by Teijin Limited) was used as the resin [II] in place of those obtained in (1-5), and the T-die temperature was changed from 200° C. to 260° C.

### Comparative Example 3

A multilayer film and a single-layer film were obtained and evaluated in the same manner as that of Example 1, except that in the step of mixing the ester compound [4] in (1-3), 8 parts of liquid paraffin (Wako special grade, manufactured by Wako Pure Chemical Industries, Ltd.), which is a plasticizer of a non-ester compound, was used in place of 8 parts of pentaerythritol distearate as the ester compound [4].

The results of Examples and Comparative Examples are collectively shown in Table 1.

TABLE 1

| | | | | | | Comp. | Comp. | Comp. |
|---|---|---|---|---|---|---|---|---|
| | Ex. 1 | Ex. 2 | Ex. 3 | Ex. 4 | Ex. 5 | Ex. 1 | Ex. 2 | Ex. 3 |
| Polymer ratio | 90 | 93 | 87 | 97.7 | 93 | 98 | 90 | 90 |
| Silane modified | 2 | 2 | 8 | 2 | 2 | 2 | 2 | 2 |
| Alkoxysilyl group | 1.7 | 1.7 | 7.0 | 1.7 | 1.7 | 1.7 | 1.7 | 1.7 |
| introduction amount | | | | | | | | |
| Ester compound | 8 | 5 | 5 | 0.3 | 5 | 0 | 0 | 0 |
| Non-ester | 0 | 0 | 0 | 0 | 0 | 0 | 8 | 8 |
| plasticizer | | | | | | | | |
| Temperature of | 48 | 50 | 48 | 55 | 50 | 56 | 48 | 48 |
| deflection under | | | | | | | | |
| load(° C.) | | | | | | | | |
| Resin | HSIS + | HSIS + | HSIS + | HSIS + | COP | HSIS + | PET | HSIS + |
| [II] | silane | silane | silane | silane | | silane | | silane |
| | modified | modified | modified | modified | | modified | | modified |
| Number of foreign | 0 | 0 | 0 | 2 | 0 | 16 | 4 | 4 |
| substances | | | | | | | | |
| Total light | 92 | 92 | 92 | 92 | 92 | 92 | 90 | 92 |
| transmittance (%) | | | | | | | | |
| Peel strength | 25 | 24 | 35 | 24 | 25 | 25 | 2 | 2 |
| with glass | | | | | | | | |
| (N/10 mm) | | | | | | | | |
| Moisture permeability | 4 | 4 | 4 | 4 | 2 | 4 | 10 | 4 |
| (g/m² · 24 h) | | | | | | | | |

The abbreviations in the table mean as follows.

Polymer ratio: a weight (parts) of the portion attributed to the hydrogenated product [2] before introduction of an alkoxysilyl group, in the alkoxysilyl group-modified product [3] of the hydrogenated product of the block copolymer in the resin [I] constituting the first resin layer.

Silane modified: a weight (parts) of the portion attributed to vinyltrimethoxysilane in the resin [I] constituting the first resin layer.

Alkoxysilyl group introduction amount: an introduction amount (parts by weight) of an alkoxysilyl group in the alkoxysilyl group-modified product.

Ester compound: a weight (parts) of an ester compound in the resin [I] constituting the first resin layer.

Non-ester plasticizer: a weight (parts) of a plasticizer of a non-ester compound in the resin [I] constituting the first resin layer.

Temperature of deflection under load: a temperature of deflection under load for the resin [I] constituting the first resin layer.

Resin [II]: a type of the resin [II] constituting the second resin layer. HSIS+silane modified: the alkoxysilyl group-modified product [3] of the hydrogenated product of the block copolymer. COP: cyclic olefin polymer resin. PET: polyethylene terephthalate.

As understood from the results of Table 1, the multilayer film satisfying the requirements of the present invention can achieve the reduced number of foreign substances, high total light transmittance, high peel strength with glass, and low water vapor permeability.

### REFERENCE SIGN LIST

100: multilayer film

110: first resin layer

110D: other surface of first resin layer

110U: a surface of first resin layer

120: second resin layer

200: melt extrusion molding machine

210: screw extruder

211: cylinder

212: screw

213: shaft

220: T die

230: cooling roll

240: hopper

250: introduction pipe

1. A multilayer film comprising: a first resin layer formed of a resin [I]; and a second resin layer that is disposed on at least one surface of the first resin layer and formed of a resin [II], wherein
the resin [I] contains an alkoxysilyl modified product [3] of a hydrogenated product of a block copolymer, and an ester compound [4],
the alkoxysilyl modified product [3] is an alkoxysilyl group-modified product of a hydrogenated product [2] obtained by hydrogenating 90% or more of an unsaturated carbon-carbon bond in a main chain and a side chain of a block copolymer [1] and an unsaturated carbon-carbon bond of an aromatic ring of the block copolymer [1],
the block copolymer [1] has two or more polymer blocks [A] per one molecule of the block copolymer [1], and one or more polymer blocks [B] per one molecule of the block copolymer [1], the polymer block [A] having an aromatic vinyl compound unit as a main component, the polymer block [B] having a chain conjugated diene compound unit as a main component,
a ratio (wA/wB) of a weight fraction wA of the polymer blocks [A] in the entire block copolymer [1] to a weight fraction wB of the polymer blocks [B] in the entire block copolymer [1] is 20/80 to 60/40, and
a ratio of the ester compound [4] in the resin [I] is 0.1% by weight to 10% by weight.

2. The multilayer film according to claim 1, wherein the resin [11] contains a polymer selected from the group consisting of a cyclic olefin polymer, the hydrogenated product [2], the alkoxysilyl modified product [3], and mixtures thereof.

3. The multilayer film according to claim 1, wherein the resin [11] contains no ester compound [4] or a content ratio of the ester compound [4] in the resin [11] is less than 0.1% by weight.

4. A method for producing the multilayer film according to claim 1, comprising
a co-extrusion molding step of coextruding the resin [I] and the resin [II] which are melted.

5. The method for producing the multilayer film according to claim 4, wherein
in the co-extrusion molding step, a melt extrusion molding machine including a screw extruder and a die is used, and
the co-extrusion molding step includes pressure-feeding the resin [I] from the screw extruder to the die.
